(19) United States
(12) Patent Application Publication
(10) Pub. No.: US 2024/0013798 A1
(43) Pub. Date: Jan. 11, 2024

(54) CONVERSION DEVICE, CONVERSION METHOD, AND CONVERSION PROGRAM

(71) Applicant: NIPPON TELEGRAPH AND TELEPHONE CORPORATION, (US)

(72) Inventors: Kazunori YAMADA, Tokyo (JP); Ko MITSUDA, Tokyo (JP); Tetsuya KINEBUCHI, Tokyo (JP); Yushi AONO, Tokyo (JP); Hiroko YABUSHITA, Tokyo (JP); Akihiko TAKASHIMA, Tokyo (JP); Takashi NAKAMURA, Tokyo (JP)

(73) Assignee: NIPPON TELEGRAPH AND TELEPHONE CORPORATION, Tokyo (JP)

(21) Appl. No.: 18/036,598

(22) PCT Filed: Nov. 13, 2020
(86) PCT No.: PCT/JP2020/042528

§ 371 Date: May 11, 2023

(51) Int. Cl. G10L 21/02; G10L 25/60

(52) U.S. Cl. CPC G10L 21/02; G10L 25/60

(57) ABSTRACT

A conversion device (10) includes: an evaluation unit (11) that estimates which one of subjective evaluation values obtained by quantifying easiness of transmission of a content of a voice felt by a person is to be taken from an input voice signal; and a conversion unit (12) that converts the input voice signal so as to obtain a subjective evaluation value of a predetermined value on the basis of the subjective evaluation value estimated by the evaluation unit (11).

### TECHNICAL FIELD

The present invention relates to a conversion device, a conversion method, and a conversion program.

### BACKGROUND ART

Conventionally, there has been proposed a voice conversion method for changing characteristics such as a frequency component and a speech speed of a voice and converting the voice into a voice of another voice quality (see, for example, Patent Literature 1).

### CITATION LIST

### Patent Literature

Patent Literature 1: Japanese Patent No. 2612869

### SUMMARY OF INVENTION

### Technical Problem

The conventional voice conversion method is a conversion aiming at an explicit operation of a parameter or a feature of a voice of a conversion destination, and thus, the voice is not necessarily converted to be easily heard subjectively by a listener.

The present invention has been made in view of the above, and an object thereof is to provide a conversion device, a conversion method, and a conversion program capable of converting an input voice into a voice that can be subjectively easily heard by a listener.

### Solution to Problem

In order to solve the above-described problems and achieve the object, a conversion device according to the present invention includes: an evaluation unit that estimates which one of subjective evaluation values obtained by quantifying easiness of transmission of a content of a voice felt by a person is to be taken from an input voice signal; and a conversion unit that converts the input voice signal so as to obtain a subjective evaluation value of a predetermined value on the basis of the subjective evaluation value estimated by the evaluation unit.

### Advantageous Effects of Invention

According to the present invention, it is possible to convert an input voice into a voice that can be subjectively easily heard by a listener.

### BRIEF DESCRIPTION OF DRAWINGS

FIG. 1 is a diagram illustrating an example of a configuration of a conversion device according to a first embodiment.

FIG. 2 is a flowchart illustrating a processing procedure of conversion processing according to the first embodiment.

FIG. 3 is a diagram illustrating an example of a configuration of a conversion device according to a second embodiment.

FIG. 4 is a flowchart illustrating a processing procedure of conversion processing according to the second embodiment.

FIG. 5 is a diagram illustrating an example of a computer in which a conversion device is implemented by executing a program.

### DESCRIPTION OF EMBODIMENTS

Hereinafter, embodiments of a conversion device, a conversion method, and a conversion program according to the present application will be described in detail with reference to the drawings. Note that the present invention is not limited to the embodiments described below.

### First Embodiment

### [Conversion Device]

First, a conversion device according to the first embodiment will be described. The conversion device according to the first embodiment converts a voice signal by using a subjective evaluation tendency for voice. The conversion device according to the first embodiment converts the input voice on the basis of the subjective evaluation value obtained by quantifying the easiness of transmission of the content of the voice felt by a person, to convert the input voice into a voice that can be subjectively easily heard by a listener, for example.

### [Conversion Device]

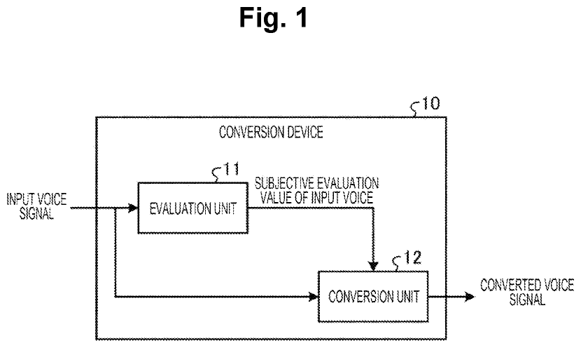

FIG. 1 is a diagram illustrating an example of a configuration of a conversion device according to the first embodiment. A conversion device 10 according to the first embodiment is implemented by, for example, a predetermined program being read by a computer or the like including a read only memory (ROM), a random access memory (RAM), a central processing unit (CPU), and the like, and the CPU executing the predetermined program.

As illustrated in FIG. 1, the conversion device 10 includes an evaluation unit 11 and a conversion unit 12. A voice signal of a speaker is input to the conversion device 10. The conversion device 10 converts the input voice signal into, for example, a voice signal that can be subjectively easily heard by a listener, and outputs the voice signal.

The evaluation unit 11 estimates which one of the subjective evaluation values is taken from the input voice signal. Here, the subjective evaluation value is obtained by quantifying the easiness of transmission of the content of the voice felt by the person.

The subjective evaluation value indicates, for example, items of easiness of understanding, naturalness of voice, easiness of understanding of contents, appropriateness of a way of taking a pause, skillfulness of a way of speaking, or a degree of impression with numerical values. The subjective evaluation value is obtained by, for example, one person or a plurality of persons evaluating a voice signal in N stages (for example, five stages) for each item, and the evaluation value evaluated for the plurality of subjective evaluation items is expressed by a vector. If the subjective evaluation value is a subjective evaluation value by a plurality of persons, for example, a value obtained by averaging the subjective evaluation values of the plurality of persons for each item is used.

The evaluation unit 11 extracts a feature amount from the input voice signal, and estimates the subjective evaluation value by using an evaluation model on the basis of the extracted feature amount. The evaluation model is a model that has learned the relationship between the feature amount of the voice signal for learning and the subjective evaluation value corresponding to the voice signal for learning.

The evaluation model learns the relationship between the feature amount of a plurality of learning voice signals to which the subjective evaluation value is given for each item and the subjective evaluation value by using, for example, a regression method using machine learning. As a result, the evaluation model estimates the subjective evaluation value on the basis of the feature amount extracted from the input voice signal.

Based on the subjective evaluation value estimated by the evaluation unit 11, the conversion unit 12 converts the input voice signal so as to obtain a subjective evaluation value of a predetermined value. For example, the conversion unit 12 sets an upper limit value of the subjective evaluation value as a predetermined value in advance as a fixed value, and converts the input voice signal so as to be the upper limit value of the subjective evaluation value.

The conversion unit 12 extracts a feature amount from the input voice signal. Then, the conversion unit 12 converts the input voice signal so as to obtain a subjective evaluation value of a predetermined value by using the conversion model on the basis of the extracted feature amount. The conversion model is a model that learns conversion from a feature amount of an input voice signal to a feature amount of a voice signal that is a subjective evaluation value of a predetermined value. At the time of conversion, the conversion unit 12 inputs the feature amount of the voice signal and the subjective evaluation value of the voice signal to the conversion model, thereby acquiring an output of the feature amount of the voice signal that is a predetermined subjective evaluation value. Then, the conversion unit 12 converts the acquired feature amount into a voice signal to obtain a voice signal that is a predetermined subjective evaluation value. The conversion unit 12 outputs the acquired voice signal to the outside as an output of the conversion device 10.

Learning of this conversion model will be described. First, a plurality of voice signals speaking the same content and a subjective evaluation value corresponding to each voice signal are set as learning data. These pieces of learning data have the same voice content but have different subjective evaluation values (naturalness, easiness of understanding, and the like). These pieces of learning data are, for example, feature amounts of voice signals to which 1 to 5 subjective evaluation values are given as learning data. For example, the conversion model learns conversion of the feature amount of the voice signal based on a difference between a subjective evaluation value of 1 (first subjective evaluation value) for the item of easiness of understanding and a subjective evaluation value of 5 (second subjective evaluation value) for the item of easiness of understanding. For example, a feature amount of a voice signal having a poor subjective evaluation value (a voice signal to which a first subjective evaluation value is given) is set as an input of a conversion model, and a feature amount of a voice signal having a good subjective evaluation value (a voice signal to which a second subjective evaluation value that is a value different from the first subjective evaluation value is given) is set as an output, and an input/output relationship is learned by using, for example, machine learning to obtain a conversion model.

During learning of the conversion model, the subjective evaluation values of the output-side and input-side voice signals are specifically used as auxiliary inputs. For example, a difference vector between the two (output-side subjective evaluation value—input-side subjective evaluation value) is used as the auxiliary input. As a result, it is possible to obtain a conversion model in which (difference between) the input/output relationship and the subjective evaluation value are associated with each other by learning.

### [Processing Procedure of Conversion Processing]

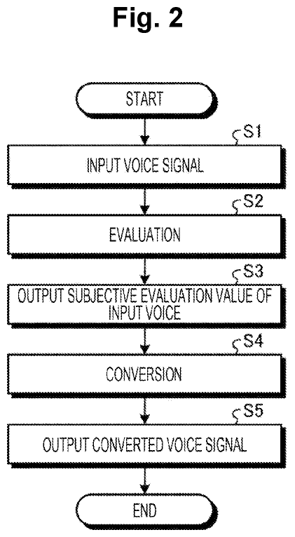

Next, conversion processing in the conversion device will be described. FIG. 2 is a flowchart illustrating a processing procedure of the conversion processing according to the first embodiment.

As illustrated in FIG. 2, when the conversion device receives an input of a voice signal (step S1), the evaluation unit 11 performs evaluation processing of estimating which one of the subjective evaluation values is to be taken from the input voice signal (step S2), and outputs the subjective evaluation value for the input voice signal (step S3).

Then, the conversion unit 12 converts the input voice signal on the basis of the subjective evaluation value estimated by the evaluation unit 11 so as to obtain a subjective evaluation value of a predetermined value (step S4), and outputs the converted voice signal (step S5).

### [Effects of First Embodiment]

As described above, in the first embodiment, which one of the subjective evaluation values is to be taken is estimated from the input voice signal, and the input voice signal is converted so as to obtain a subjective evaluation value of a predetermined value on the basis of the estimated subjective evaluation value. The subjective evaluation value is obtained by quantifying the easiness of transmission of the content of the voice felt by a person, and is obtained by evaluating, for example, easiness of understanding, naturalness of voice, easiness of understanding of a content, appropriateness of a way of taking a pause, skillfulness of a way of speaking, or a degree of impression in stages.

In the first embodiment, the input voice signal is converted on the basis of the above-described subjective evaluation value estimated from the input voice signal so that, for example, the subjective evaluation value is the upper limit value. Therefore, according to the first embodiment, by utilizing not only objective characteristics or physical characteristics of a voice signal but also a subjective evaluation value of a listener, it is easy for the listener to subjectively listen and it is possible to convert the voice signal into a natural voice signal.

Then, in the first embodiment, an evaluation model that estimates a subjective evaluation value of an input voice signal by learning a correspondence relationship between the voice signal and the subjective evaluation value, and a conversion model that converts the input voice signal into a voice signal that is a predetermined subjective evaluation value by learning a plurality of voice signals and the subjective evaluation value of each voice signal are used. Therefore, in the first embodiment, by utilizing the correspondence relationship between the voice signal and the subjective evaluation value for the evaluation and conversion of the voice signal, it is possible to appropriately convert the input voice signal into a voice signal that is subjectively easily heard by the listener according to the feature.

### Second Embodiment

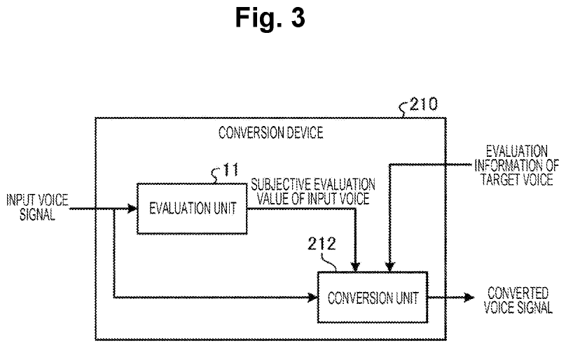

Next, a second embodiment will be described. FIG. 3 is a diagram illustrating an example of a configuration of a conversion device according to the second embodiment.

As illustrated in FIG. 3, a conversion device 210 according to the second embodiment includes a conversion unit 212 instead of the conversion unit 12 illustrated in FIG. 1. Furthermore, the conversion device 210 receives an input of a voice signal to be converted and also receives an input of evaluation information of a target voice. Specifically, the evaluation information of the target voice is a subjective evaluation value that is a target of the converted voice signal. Furthermore, in a case where the subjective evaluation value has a plurality of items, a target value is set for each item. Note that a predetermined subjective evaluation value is a fixed value in the first embodiment, but is a target subjective evaluation value input from the outside in the second embodiment.

The conversion unit 212 converts the input voice signal so that the subjective evaluation value estimated by the evaluation unit 11 is a subjective evaluation value taken as a target. The conversion unit 212 converts the input voice signal so as to be a target subjective evaluation value input from the outside (for example, a listener or a speaker). The subjective evaluation value taken as the target may be input as evaluation information as to how much the speaker himself/herself wants to improve his/her voice as the target voice.

The conversion unit 212 extracts a feature amount from the input voice signal. Then, based on the extracted feature amount, the conversion unit 212 converts the input voice signal into a target subjective evaluation value using the conversion model. The conversion model is a model that learns conversion from a feature amount of an input voice signal to a feature amount of a voice signal that is a target subjective evaluation value. At the time of conversion, the conversion unit 212 inputs the feature amount of the voice signal and the subjective evaluation value of the voice signal to the conversion model, thereby obtaining an output of the feature amount of the converted voice signal that is a target subjective evaluation value. Then, the conversion unit 212 converts the acquired feature amount into a voice signal to obtain a voice signal that is a target subjective evaluation value. The conversion unit 212 outputs the acquired voice signal to the outside as an output of the conversion device 210. Note that the learning of the conversion model may be performed similarly to the first embodiment.

### [Processing Procedure of Conversion Processing]

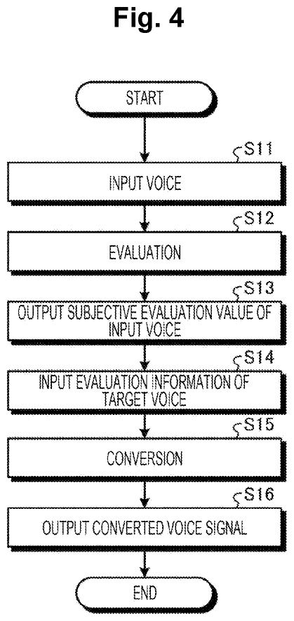

Next, conversion processing in the conversion device 210 will be described. FIG. 4 is a flowchart illustrating a processing procedure of conversion processing according to the second embodiment.

Steps S11 to S13 illustrated in FIG. 3 are the same processing as steps S1 to S3 illustrated in FIG. 2. Upon receiving the input of the evaluation information of the target voice (step S14), the conversion device 210 converts the input voice signal on the basis of the subjective evaluation value estimated by the evaluation unit 11 so as to obtain a target subjective evaluation value indicated by the evaluation information of the target voice (step S15), and outputs the converted voice signal (step S16).

### [Effects of Second Embodiment]

As described above, in the second embodiment, the input voice signal is converted such that the subjective evaluation value of the voice signal estimated by the evaluation unit 11 is a subjective evaluation value taken as the target. Here, in the first embodiment, an example in which the subjective evaluation value after conversion is fixed has been described. If the subjective evaluation value after the conversion is fixed as in the first embodiment, there may be a case where it is difficult to cope with flexible and complicated conversion according to various situations and listeners.

On the other hand, in the second embodiment, by enabling the target subjective evaluation value to be explicitly input, it is possible to flexibly cope with a complicated case where a desired voice is set in different stages for each item, and it is possible to convert the voice signal into a voice signal suitable for a listener.

### [System Configuration Etc.]

Each component of each device that has been illustrated is functionally conceptual, and is not necessarily physically configured as illustrated. That is, a specific form of distribution and integration of each device is not limited to the illustrated form. All or some of the components may be functionally or physically distributed and integrated in an arbitrary unit according to various loads, usage conditions, and the like. For example, the conversion device 10, 210 may be an integrated device. Furthermore, all or any part of each processing function performed in each device can be implemented by a CPU and a program analyzed and executed by the CPU, or can be implemented as hardware by wired logic.

Further, among pieces of processing described in the present embodiment, all or some of pieces of processing described as being performed automatically can be performed manually, or all or some of pieces of processing described as being performed manually can be performed automatically by a known method. In addition, each processing described in the present embodiment may be executed not only in the described order and thus in time series, but also in parallel or individually according to the processing capability of the device that executes the processing or as necessary. In addition, the processing procedures, the control procedures, the specific names, and the information including various data and parameters illustrated in the specification and the drawings can be arbitrarily changed unless otherwise specified.

### [Program]

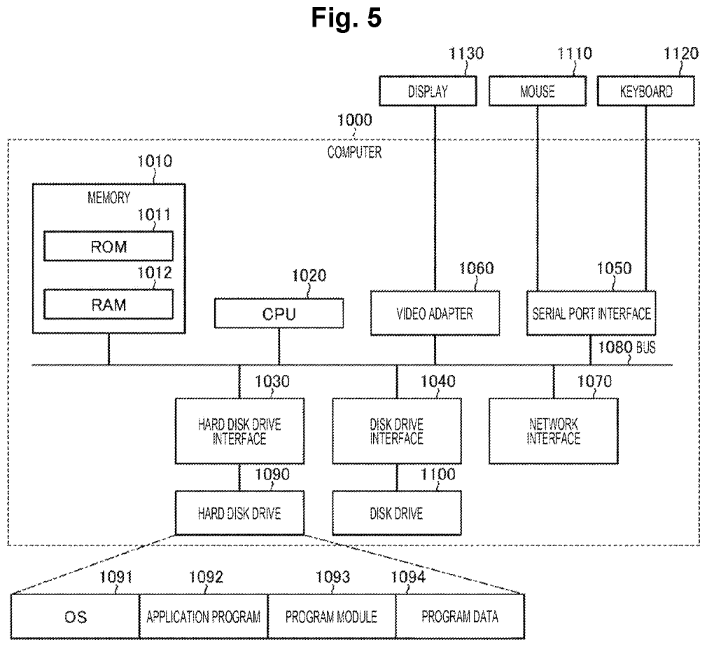

FIG. 5 is a diagram illustrating an example of a computer in which the conversion device 10, 210 is implemented by executing a program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1110 and a keyboard 1120. The video adapter 1060 is connected to, for example, a display 1130.

The hard disk drive 1031 stores, for example, an OS 1091, an application program 1092, a program module 1093, and program data 1094. That is, the program that defines each processing of the conversion device 10, 210 is implemented as a program module 1093 in which a code executable by the computer 1000 is described. The program module 1093 is stored in, for example, the hard disk drive 1031. For example, the program module 1093 for executing processing similar to the functional configuration in the conversion device 10, 210 is stored in the hard disk drive 1031. Note that the hard disk drive 1031 may be replaced with a solid state drive (SSD).

In addition, the setting data used in the processing of the above-described embodiment is stored, for example, in the memory 1010 or the hard disk drive 1031 as the program data 1094. Then, the CPU 1020 reads the program module 1093 and the program data 1094 stored in the memory 1010 and the hard disk drive 1031 to the RAM 1012 as necessary and executes them.

Note that the program module 1093 and the program data 1094 are not limited to being stored in the hard disk drive 1031, and may be stored in, for example, a removable storage medium and read by the CPU 1020 via the disk drive 1041 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070. Furthermore, the processing of the neural network used in the conversion device 10, 210 and the learning device 20, 220, 320, 420 may be executed using a GPU.

Although the embodiment to which the invention made by the present inventor is applied has been described above, the present invention is not limited by the description and drawings constituting a part of the disclosure of the present invention according to the present embodiment. In other words, other embodiments, examples, operation techniques, and the like made by those skilled in the art and the like on the basis of the present embodiments are all included in the scope of the present invention.

### REFERENCE SIGNS LIST

210 Conversion device
11 Evaluation unit
12, 212 Conversion unit

1. A conversion device comprising a processor configured to execute operations comprising:
estimating a subjective evaluation value of a plurality of subjective evaluation values, wherein the estimating the subjective evaluation value further comprises obtaining the subjective evaluation value by quantifying easiness of transmission of a content of a voice felt by a person is to be taken from an input voice signal; and
converting the input voice signal to indicate a predetermined subjective evaluation value based on the estimated subjective evaluation value.

2. The conversion device according to claim 1, wherein the estimating further comprises estimating subjective evaluation information from a feature amount of an input voice signal by using an evaluation model wherein the evaluation model has learned a relationship between a feature amount of a voice signal for learning and a subjective evaluation value of the voice signal for learning.

3. The conversion device according to claim 1, wherein the converting further comprises converting an input voice signal into a voice signal, wherein the voice signal is a subjective evaluation value of a predetermined value by using a conversion model, wherein the conversion model has learned conversion of a feature amount of the voice signal according to a difference between a first subjective evaluation value and a second subjective evaluation value, wherein the second subjective evaluation value is distinct from the first subjective evaluation value based on a voice signal for learning to which the first subjective evaluation value is given and a voice signal for learning to which the second subjective evaluation value is given.

4. The conversion device according to claim 1, wherein the input voice signal is converted such that the subjective evaluation value is the subjective evaluation value taken as a target.

5. The conversion device according to claim 1, wherein the subjective evaluation value indicates at least one of:
easiness of understanding,
naturalness of voice,
easiness of understanding of a content,
appropriateness of a way of taking a pause,
skillfulness of a way of speaking, or
a degree of impression with numerical values.

6. A conversion method comprising:
estimating a subjective evaluation value of a plurality of subjective evaluation values, wherein the estimating the subjective evaluation value further comprises obtaining the subjective evaluation value by quantifying easiness of transmission of a content of a voice felt by a person is to be taken from an input voice signal; and
converting the input voice signal so as to indicate a predetermined subjective evaluation value based on the estimated subjective evaluation value.

7. A computer-readable non-transitory recording medium storing computer-executable program instructions that when executed by a processor cause a computer system to execute operations comprising:
estimating a subjective evaluation value of a plurality of subjective evaluation values, wherein the estimating the subjective evaluation value further comprises obtaining the subjective evaluation value by quantifying easiness of transmission of a content of a voice felt by a person is to be taken from an input voice signal; and
converting the input voice signal to indicate a predetermined subjective evaluation value based on the estimated subjective evaluation value estimated in the estimating step.

8. The conversion device according to claim 2, wherein the converting further comprises converting an input voice signal into a voice signal, wherein the voice signal is a subjective evaluation value of a predetermined value by using a conversion model, wherein the conversion model has learned conversion of a feature amount of the voice signal according to a difference between a first subjective evaluation value and a second subjective evaluation value, wherein the second subjective evaluation value is distinct from the first subjective evaluation value based on a voice signal for learning to which the first subjective evaluation value is given and a voice signal for learning to which the second subjective evaluation value is given.

9. The conversion method according to claim 6, wherein the estimating further comprises estimating subjective evaluation information from a feature amount of an input voice signal by using an evaluation model, wherein the evaluation model has learned a relationship between a feature amount of a voice signal for learning and a subjective evaluation value of the voice signal for learning.

10. The conversion method according to claim 6, wherein the converting further comprises converting an input voice signal into a voice signal, wherein the voice signal is a subjective evaluation value of a predetermined value by using a conversion model, wherein the conversion model has learned conversion of a feature amount of the voice signal according to a difference between a first subjective evaluation value and a second subjective evaluation value, wherein the second subjective evaluation value is distinct from the first subjective evaluation value based on a voice signal for learning to which the first subjective evaluation value is given and a voice signal for learning to which the second subjective evaluation value is given.

11. The conversion method according to claim 6, wherein the input voice signal is converted such that the subjective evaluation value is the subjective evaluation value taken as a target.

12. The conversion method according to claim 6, wherein the subjective evaluation value indicates at least one of:
easiness of understanding,
naturalness of voice,
easiness of understanding of a content,
appropriateness of a way of taking a pause,
skillfulness of a way of speaking, or
a degree of impression with numerical values.

13. The conversion method according to claim 9, wherein the converting further comprises converting an input voice signal into a voice signal, wherein the voice signal is a subjective evaluation value of a predetermined value by using a conversion model, wherein the conversion model has learned conversion of a feature amount of the voice signal according to a difference between a first subjective evaluation value and a second subjective evaluation value, wherein the second subjective evaluation value is distinct from the first subjective evaluation value based on a voice signal for learning to which the first subjective evaluation value is given and a voice signal for learning to which the second subjective evaluation value is given.

14. The computer-readable non-transitory recording medium according to claim 7, wherein the estimating further comprises estimating subjective evaluation information from a feature amount of an input voice signal by using an evaluation model, wherein the evaluation model has learned a relationship between a feature amount of a voice signal for learning and a subjective evaluation value of the voice signal for learning.

15. The computer-readable non-transitory recording medium according to claim 7, wherein the converting further comprises converting an input voice signal into a voice signal, wherein the voice signal is a subjective evaluation value of a predetermined value by using a conversion model, wherein the conversion model has learned conversion of a feature amount of the voice signal according to a difference between a first subjective evaluation value and a second subjective evaluation value, wherein the second subjective evaluation value is distinct from the first subjective evaluation value based on a voice signal for learning to which the first subjective evaluation value is given and a voice signal for learning to which the second subjective evaluation value is given.

16. The computer-readable non-transitory recording medium according to claim 7, wherein the input voice signal is converted such that the subjective evaluation value is the subjective evaluation value taken as a target.

17. The computer-readable non-transitory recording medium according to claim 7, wherein the subjective evaluation value indicates at least one of:
easiness of understanding,
naturalness of voice,
easiness of understanding of a content,
appropriateness of a way of taking a pause,
skillfulness of a way of speaking, or
a degree of impression with numerical values.

18. The computer-readable non-transitory recording medium according to claim 14, wherein the converting further comprises converting an input voice signal into a voice signal, wherein the voice signal is a subjective evaluation value of a predetermined value by using a conversion model, wherein the conversion model has learned conversion of a feature amount of the voice signal according to a difference between a first subjective evaluation value and a second subjective evaluation value, wherein the second subjective evaluation value is distinct from the first subjective evaluation value based on a voice signal for learning to which the first subjective evaluation value is given and a voice signal for learning to which the second subjective evaluation value is given.
